(19) United States
(12) Patent Application Publication
(10) Pub. No.: US 2023/0061051 A1
(43) Pub. Date: Mar. 2, 2023

(54) ILLUMINATION SYSTEM

(71) Applicant: SAVANT TECHNOLOGIES LLC, Cleveland, OH (US)

(72) Inventors: Minjie JI, Shanghai (CN); Huisheng ZHOU, Shanghai (CN); Shen YANG, Shanghai (CN); Pan YAO, Shanghai (CN)

(73) Assignee: SAVANT TECHNOLOGIES LLC, Cleveland, OH (US)

(21) Appl. No.: 17/892,926

(22) Filed: Aug. 22, 2022

(30) Foreign Application Priority Data
Aug. 26, 2021 (CN) 202110989621.7

(51) Int. Cl. F21S 2/00; F21V 23/06; F21V 23/00; F21V 23/04

(52) U.S. Cl. CPC F21S 2/005; F21V 23/06; F21V 23/003; F21V 23/0464; F21V 23/045

(57) ABSTRACT

The present application relates to an illumination system. The illumination system comprises: a first electric appliance driver, wherein a second electric appliance driver is electrically connected to the first electric appliance driver and is configured to receive power-source power from the first electric appliance driver, to convert the power-source power into driving power, and also to perform signal detection on the power-source power and generate a control signal for controlling an illumination unit and related accessories. The technical solution of the present application facilitates providing of power or control signals to an illumination unit and related accessories.

### CROSS-REFERENCE TO RELATED APPLICATIONS

This application claims the benefit of Chinese Patent Application Serial Number 202110989621.7, filed Aug. 26, 2021, which is herein incorporated by reference.

### DESCRIPTION

### Field of Technology

The present application relates to the field of electrical control. In particular, the present application relates to an illumination system.

### Background

An existing illumination apparatus is controlled by a switch. For example, a light in a room is controlled to emit light or to turn off by means of a switch on a wall.

Other accessories may be additionally mounted on the illumination apparatus, such as a night light. These accessories need to be powered for driving or controlling the accessories, and thus additional power sources or power lines need to be provided. In addition, if it is desired to take power from the illumination apparatus, a power supply line of the illumination apparatus needs to be changed or the structure of the illumination apparatus needs to be changed, which makes it necessary to separately design a circuit and a structure which is adapted to the illumination apparatus for the accessories, increasing the design and manufacturing costs, improving the complexity of a system, and making it is not easy to mount accessories on the illumination apparatus.

### SUMMARY

The embodiments of the present application provide an illumination system, so as to at least solve the problem in the prior art that it is not easy to mount electrical accessories on an illumination apparatus.

According to one aspect of embodiments of the present application, an illumination system is provided, comprising: a first electric appliance driver, a second electric appliance driver and one or more additional illumination units, wherein the second electric appliance driver is configured to be electrically connected to the first electric appliance driver and to be electrically connected to at least one additional illumination unit of the one or more additional illumination units, and wherein the first electric appliance driver can be directly electrically connected to an illumination unit, to form an independent another illumination system.

In this way, it is convenient to provide power or control signals to the illumination unit.

According to an exemplary embodiment of the present application, the illumination system further comprises the illumination unit, wherein the illumination unit is configured to be electrically connected to the second electric appliance driver to receive driving power, and the additional illumination units are configured to be electrically connected to the second electric appliance driver to receive driving power.

In this way, power or control signals can be provided to a plurality of different illumination units and related accessories.

According to an exemplary embodiment of the present application, the illumination system further comprises the illumination unit, wherein the illumination unit is configured to be electrically connected to the first electric appliance driver to receive driving power, the additional illumination units are configured to be electrically connected to the second electric appliance driver to receive driving power, and the second electric appliance driver receives power-source power from the first electric appliance driver.

In this way, power or control signals can be respectively provided to a plurality of different illumination units and related accessories.

According to an exemplary embodiment of the present application, the second electric appliance driver comprises: a power conversion module, a power storage and release apparatus and a control signal generation module, wherein the power conversion module is configured to be electrically connected to the first electric appliance driver to receive the power-source power, and convert the power-source power into driving power, the power storage and release apparatus is configured to be electrically connected to the power conversion module to receive the driving power, so as to drive the additional illumination units, and the control signal generation module is configured to receive the driving power from the power conversion module, is also configured to receive the driving power from the power storage and release apparatus, and is also configured to sample an output signal of the first electric appliance driver, and to control, according to the output signal, whether the power conversion module operates and whether the power storage and release apparatus discharges.

In this way, separate control and drive of the additional illumination units can be achieved.

According to an exemplary embodiment of the present application, the control signal generation module comprises: a control logic module, a detection module and a sensor module, wherein the control logic module stores a control logic, the detection module is configured to sample the output signal of the first electric appliance driver, and the sensor module is configured to measure an environmental parameter associated with the control logic, and wherein the control signal generation module is configured to generate, on the basis of the sampled output signal, the environmental parameter and the control logic and under driving of the driving power, a control signal for controlling whether the power conversion module operates and whether the power storage and release apparatus discharges.

In this way, the additional illumination units can be controlled and driven according to the control logic.

According to an exemplary embodiment of the present application, the output signal sampled by the detection module represents the magnitude of the power-source power outputted by the first electric appliance driver, the environmental parameter represents whether the brightness around the additional illumination units is below a threshold, and the control logic at least comprises: if the first electric appliance driver provides the power-source power, controlling the additional illumination units to be turned off and charging the power storage and release apparatus; if the first electric appliance driver does not provide the power-source power and the brightness around the additional illumination units is below the threshold, controlling the power storage and release apparatus to release the driving power so as to drive the additional illumination units to be turned on; and if the first electric appliance driver does not provide the power-source power and the brightness around the additional illumination units is above the threshold, controlling the power storage and release apparatus not to release the driving power for driving the additional illumination units, and the additional illumination units being turned off.

In this way, the additional illumination units can be turned on when the brightness around the illumination unit is low, and the additional illumination units are turned off when the illumination unit is turned on.

According to an exemplary embodiment of the present application, the environmental parameter representing the brightness around the additional illumination units is acquired by a photosensitive sensor arranged on the second electric appliance driver or the additional illumination units.

In this way, the environmental parameter representing the brightness around the additional illumination units can be acquired.

According to an exemplary embodiment of the present application, the illumination unit is an illumination system light, and the additional illumination units are night lights, wherein the night lights are assembled around the illumination system light.

In this way, the illumination system light can be provided with a night light function.

According to an exemplary embodiment of the present application, the second electric appliance driver comprises a power conversion module and a wireless control module, wherein the wireless control module is configured to receive a wireless signal, and is configured to output a signal to the power conversion module after receiving the wireless signal; and the power conversion module has a light adjustment function, so as to turn on or turn off the one or more additional illumination units or adjust the brightness of light emitted by the one or more additional illumination units according to the signal outputted from the wireless control module.

In this way, wireless control of the illumination unit can be achieved.

According to an exemplary embodiment of the present application, the wireless signal is a Bluetooth signal, a Wi-Fi signal, an infrared signal or other wireless signals.

In this way, multiple wireless signals can be provided.

According to an exemplary embodiment of the present application, the second electric appliance driver comprises a function control module, wherein the function control module is configured to control the one or more additional illumination units to achieve one or more functions of turning on at night, turning on periodically and music rhythm.

In this way, multiple special control of the additional illumination units can be achieved.

According to an exemplary embodiment of the present application, the second electric appliance driver further comprises a power storage and release apparatus, wherein if the first electric appliance driver provides power-source power, the power storage and release apparatus is charged, and the power storage and release apparatus is configured to provide driving power to the one or more additional illumination units.

In this way, driving power can be stored for the additional illumination units.

In embodiments of the present application, an illumination system is provided, electric appliance drivers are provided between a power source and an illumination apparatus, and an illumination system which controls the illumination apparatus merely by a switch is configured to be a system which can control multiple illumination apparatuses according to a control logic, can also wirelessly control the illumination apparatuses, or can achieve a function of performing multiple special control on the illumination apparatuses, so as to at least solve the technical problem that it is not easy to add electrical accessories to the illumination apparatus, and achieve the technical effects of facilitating mounting of a night light, improving power supply and control of the illumination apparatus, and being compatible with other electrical devices.

### BRIEF DESCRIPTION OF THE DRAWINGS

The drawings illustrated herein are used for providing further understanding of the present application and constitute a part of the present application, and the illustrative embodiments of the present application and illustrations thereof are used to explain the present application, rather than constitute inappropriate limitation on the present application. In the drawings:

FIG. 1 is a schematic diagram of an electric appliance driver directly driving an illumination unit;

FIG. 2 is a schematic diagram of an illumination system according to the present application;

FIG. 3 is a schematic diagram of an illumination system according to an exemplary embodiment of the present application;

FIG. 4 is a schematic diagram of an illumination system according to an exemplary embodiment of the present application;

FIG. 5 is a schematic diagram of an illumination system according to an exemplary embodiment of the present application;

FIG. 6 is a schematic diagram of an illumination system according to an exemplary embodiment of the present application;

FIG. 7 is a schematic diagram of an illumination system according to an exemplary embodiment of the present application;

FIG. 8 is a schematic connection diagram of an electric appliance driver directly driving an illumination unit;

FIG. 9 is a schematic connection diagram of an illumination system according to an embodiment of the present application;

FIG. 10 is a schematic connection diagram of an illumination system according to another exemplary embodiment of the present application; and

FIG. 11 is a schematic connection diagram of an illumination system according to another exemplary embodiment of the present application.

### DETAILED DESCRIPTION

In order to make a person skilled in the art better understand the solutions of the present application, hereinafter, the technical solutions in the embodiments of the present application will be described clearly and thoroughly with reference to the accompanying drawings of the present application. Obviously, the embodiments as described are only some of the embodiments of the present application, and are not all the embodiments. All other embodiments obtained by a person of ordinary skill in the art based on the embodiments of the present application without any inventive effort shall all fall within the scope of protection of the present application.

It should be noted that the terms “first”, “second” etc., in the description, claims, and accompanying drawings of the present application are used to distinguish similar objects, and are not necessarily used to describe a specific sequence or order. It should be understood that the data so used may be interchanged where appropriate, so that the embodiments of the present application described herein can be implemented in sequences other than those illustrated or described herein. In addition, the terms “comprise” and “have”, and any variations thereof are intended to cover a non-exclusive inclusion, for example, a process, method, system, product, or device that comprises a series of steps or modules or units is not necessarily limited to those steps or modules or units that are clearly listed, but may comprise other steps or modules or units that are not clearly listed or inherent to such process, method, product, or device.

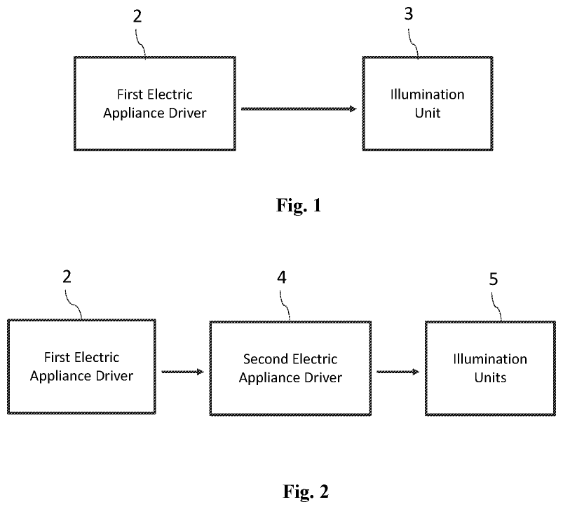

FIG. 1 is a schematic diagram of an electric appliance driver directly driving an illumination unit. As shown in FIG. 1, a first electric appliance driver 2 is directly connected to an illumination unit 3, so as to supply power to the illumination unit 3. For example, the illumination unit 3 is an illumination light provided in a room, and is controlled by a switch provided on a wall. When the switch is turned on, the first electric appliance driver 2 supplies power to the illumination unit 3, and the illumination unit 3 is turned on and emits light. When the switch is turned off, the first electric appliance driver 2 does not supply power to the illumination unit 3, and the illumination unit 3 is turned off.

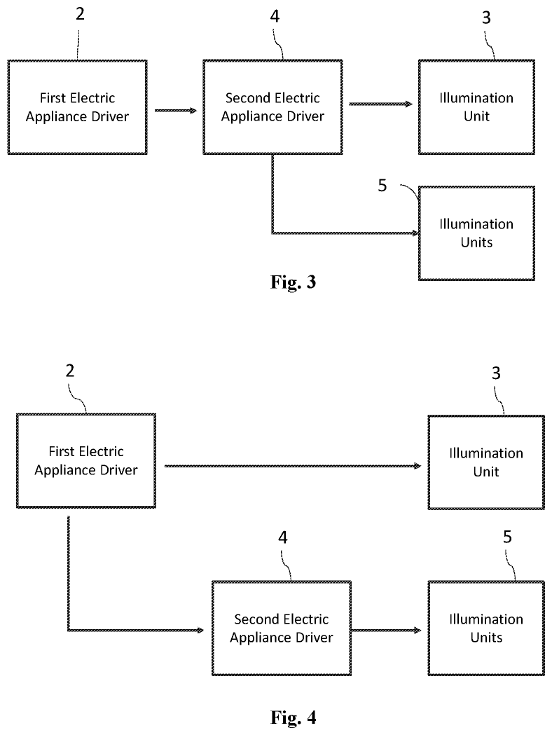

FIG. 2 is a schematic diagram of an illumination system according to an exemplary embodiment of the present application. As shown in FIG. 2, the illumination system comprises: a first electric appliance driver 2, a second electric appliance driver 4 and one or more additional illumination units 5 (only one block 5 is shown in the figure, but the number of the illumination units 5 can be one, two, three or more).

The second electric appliance driver 4 is configured to be electrically connected to the first electric appliance driver 2, and to be electrically connected to at least one illumination unit 5 of the one or more additional illumination units 5, wherein the first electric appliance driver 2 can be directly electrically connected to the illumination unit 3, to form an independent another illumination system, refer to FIG. 1.

FIG. 3 is a schematic diagram of an illumination system according to an exemplary embodiment of the present application. As shown in FIG. 3, according to an exemplary embodiment of the present application, in addition to the additional illumination units 5, the illumination system further comprises the illumination unit 3. The illumination unit 3 is configured to be electrically connected to the second electric appliance driver 4 to receive driving power, and the additional illumination units 5 are configured to be electrically connected to the second electric appliance driver 4 to receive driving power. In this way, power or control signals can be provided to a plurality of different illumination units and related accessories.

FIG. 4 is a schematic diagram of an illumination system according to an exemplary embodiment of the present application. As shown in FIG. 4, according to an exemplary embodiment of the present application, in addition to the additional illumination units 5, the illumination system further comprises the illumination unit 3. The illumination unit 3 is configured to be electrically connected to the first electric appliance driver 2 to receive driving power, the additional illumination units 5 are configured to be electrically connected to the second electric appliance driver 4 to receive driving power, and the second electric appliance driver 4 receives power-source power from the first electric appliance driver 2. In this way, power or control signals can be respectively provided to a plurality of different illumination units and related accessories.

FIG. 5 is a schematic diagram of an illumination system according to an exemplary embodiment of the present application. As shown in FIG. 5, according to an exemplary embodiment of the present application, the second electric appliance driver 4 comprises: a power conversion module 13, a power storage and release apparatus 14 and a control signal generation module 15, wherein the power conversion module 13 is configured to be electrically connected to the first electric appliance driver 2 so as to receive the power-source power, and convert the power-source power into driving power; the power storage and release apparatus 14 is configured to be electrically connected to the power conversion module 13 to receive the driving power, so as to drive the additional illumination units 5; and the control signal generation module 15 is configured to receive the driving power from the power conversion module 13, is also configured to receive the driving power from the power storage and release apparatus 14, and is also configured to sample an output signal of the first electric appliance driver 2, and to control, according to the output signal, whether the power conversion module 13 operates and whether the power storage and release apparatus 14 discharges. In this way, separate control and drive of the additional illumination units can be achieved.

As shown in FIG. 5, according to an exemplary embodiment of the present application, the control signal generation module 15 comprises: a control logic module 151, a detection module 153 and a sensor module 152; wherein the control logic module 151 stores a control logic; the detection module 153 is configured to sample an output signal of the first electric appliance driver 2, and the sensor module 152 is configured to measure an environmental parameter associated with the control logic, wherein the control signal generation module 15 is configured to generate, on the basis of the sampled output signal, the environmental parameter and the control logic and under driving of the driving power, a control signal for controlling whether the power conversion module 13 operates and whether the power storage and release apparatus 14 discharges. In this way, the additional illumination units can be controlled and driven according to the control logic.

In an exemplary embodiment, the control signal generation module 15 comprises a voltage or current detection module configured to detect an input voltage or current signal of the power conversion module 13, and to achieve enable control on the power conversion module 13 according to the signal. The control logic module 151 is also configured to receive external other signals by means of the sensor module 152 and to perform discharge on/off or adjustment control on the power storage and release apparatus 14 according to the signal. In an exemplary embodiment, the control signal generation module 15 is a control module of a night light driver configured to provide a control signal to the night light driver so as to control the night light to be turned on or off. In another exemplary embodiment, the control signal generation module 15 can generate control signals of other illumination units 3, for example, signals which control the turning on or off of a canless light.

In an exemplary embodiment, the illumination unit 3 is a night light, and the additional illumination units 5 are canless lights. If the canless lights are turned off, the night light may need to be turned on; at this time, the first electric appliance driver 2 does not supply power-source power, and it is necessary to supply power to the night light by means of the power storage and release apparatus 14. A battery in the power storage and release apparatus 14 may be batteries of any form, such as a rechargeable battery. In this way, power can be stored for the illumination unit, such that power can also be provided to the illumination unit when a power source does not provide power-source power.

In an exemplary embodiment, the control signal generation module 15 is also configured to receive external other signals by means of the sensor module 152, and to perform discharge on/off or adjustment control on the power storage and release apparatus 14 according to the signals. The sensor module 152 can also be provided together with the additional illumination units 5. In this way, specific control signals can be generated according to different conditions and requirements.

According to an exemplary embodiment of the present application, the output signal sampled by the detection module 153 represents the magnitude of the power-source power outputted by the first electric appliance driver 2, the environmental parameter represents whether the brightness around the additional illumination units 5 is below a threshold, and the control logic at least comprises: if the first electric appliance driver 2 provides the power-source power, controlling the additional illumination units 5 to be turned off and charging the power storage and release apparatus 14; if the first electric appliance driver 2 does not provide the power-source power and the brightness around the additional illumination units 5 is below the threshold, controlling the power storage and release apparatus 14 to release the driving power so as to drive the additional illumination units 5 to be turned on; and if the first electric appliance driver 2 does not provide the power-source power and the brightness around the additional illumination units 5 is above the threshold, controlling the power storage and release apparatus 14 not to release the driving power for driving the additional illumination units 5, and the additional illumination units 5 being turned off. In this way, the additional illumination units can be turned on when the brightness around the illumination unit is low, and the additional illumination units are turned off when the illumination unit is turned on.

In an exemplary embodiment, if a switch of the power source is turned on, the power source provides power-source power, for example, the illumination unit 3 of a canless light is turned on and emits light, and at this time, the additional illumination units 5 such as night lights do not need to emit light, and thus the additional illumination units 5 are controlled to be turned off, and at the same time, the power storage and release apparatus 14 can be controlled to be charged, so as to subsequently supply power to the additional illumination units 5. If the switch of the power source is turned off, the power source does not supply power-source power, for example, the illumination unit 3 of a canless light is turned off and does not emit light. If the ambient light is dark, for example the brightness around the additional illumination units 5 is below a threshold, then additional illumination units 5 such as night lights need to be turned on, thereby controlling the additional illumination units 5 to be turned on and emit light. If the ambient light is sufficient, for example the brightness around the additional illumination units 5 is above the threshold, the night light does not need to be turned on, thereby controlling the additional illumination units 5 to be turned off and not to emit light. It should be understood that the control logic can be adjusted and set as required, and is not limited to the specific control logic in an exemplary embodiment of the present application. In this way, a power storage apparatus can be charged when the power source supplies power, and when the illumination unit is turned off, the additional illumination units are turned on if the light is dark, and the additional illumination units are turned off if the light is sufficient.

According to an exemplary embodiment of the present application, the environmental parameter representing the brightness around the additional illumination units 5 is acquired by a photosensitive sensor arranged on the second electric appliance driver 4 or the additional illumination units 5. In this way, the environmental parameter representing the brightness around the additional illumination units can be acquired.

According to an exemplary embodiment of the present application, the illumination unit 3 is an illumination system light, and the additional illumination units 5 are night lights, wherein the night lights are assembled around the illumination system light. In this way, the illumination system light can be provided with a night light function.

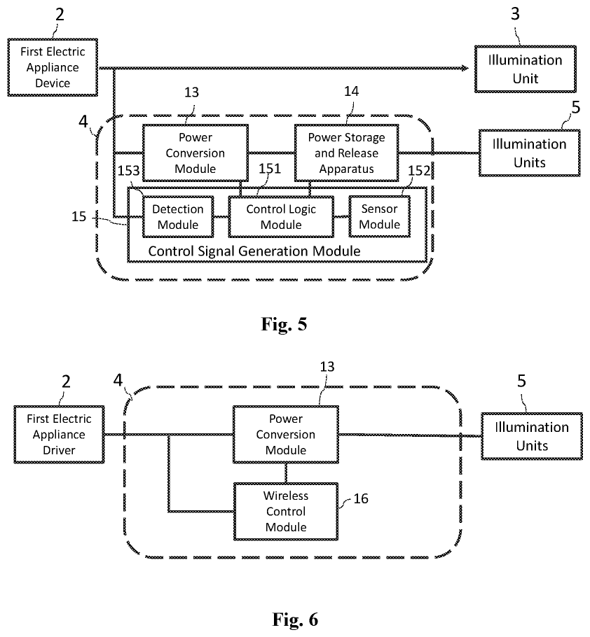

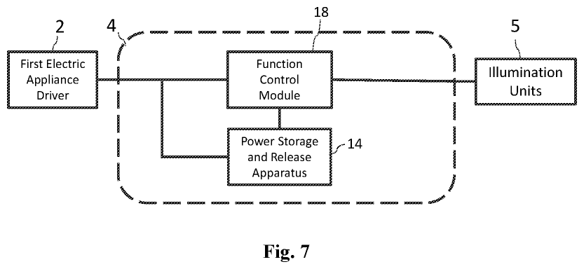

FIG. 6 is a schematic diagram of an illumination system according to an exemplary embodiment of the present application. As shown in FIG. 6, according to an exemplary embodiment of the present application, the second electric appliance driver 4 comprises a power conversion module 13 and a wireless control module 16, wherein the wireless control module 16 is configured to receive a wireless signal, and is configured to output a signal to the power conversion module 13 after receiving the wireless signal, and the power conversion module 13 has a light adjustment function, so as to turn on or turn off the one or more additional illumination units 5 or adjust the brightness of light emitted by the one or more additional illumination units 5 according to the signal outputted from the wireless control module. In this way, wireless control of the illumination unit can be achieved. For example, the wireless control module 16 is configured to output a PWM signal to the power conversion module 13 after receiving the wireless signal, and the power conversion module 13 has a PWM light adjustment function, so as to achieve turning on or turning off or light adjustment function of the additional illumination units 5 according to the PWM signal outputted from the wireless control module 16. Here, the additional illumination units 5 may be illumination units of any form, including but not limited to, an illumination system light, a night light.

According to an exemplary embodiment of the present application, the wireless signal is a Bluetooth signal, a Wi-Fi signal, an infrared signal, or other wireless signals. In this way, multiple wireless signals can be provided.

FIG. 7 is a schematic diagram of an illumination system according to an exemplary embodiment of the present application. As shown in FIG. 7, according to an exemplary embodiment of the present application, the second electric appliance driver 4 comprises a function control module 18, wherein the function control module 18 is configured to control the one or more additional illumination units 5 to achieve one or more functions of turning on at night, turning on periodically and music rhythm.

In this way, multiple special control of the additional illumination units can be achieved.

According to an exemplary embodiment of the present application, the second electric appliance driver 4 further comprises a power storage and release apparatus 14, wherein if the first electric appliance driver 2 provides power-source power, the power storage and release apparatus 14 is charged, and the power storage and release apparatus 14 is configured to provide driving power to the one or more additional illumination units 5. In this way, driving power can be stored for the additional illumination units.

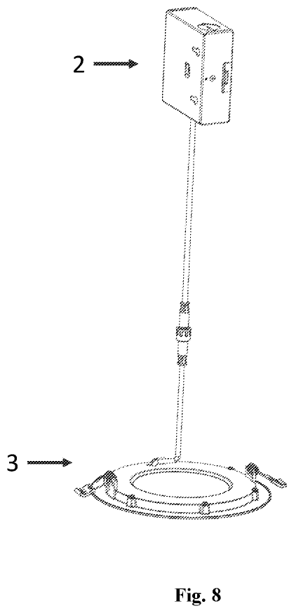

FIG. 8 is a schematic connection diagram of an electric appliance driver directly driving an illumination unit. As shown in FIG. 8, a first electric appliance driver 2 is directly connected to an illumination unit 3, so as to supply power to the illumination unit 3. For example, the illumination unit 3 is an illumination light provided in a room, and is controlled by a switch provided on a wall. When a switch is turned on, the first electric appliance driver 2 supplies power to the illumination unit 3, and the illumination unit 3 is turned on and emits light. When the switch is turned off, the first electric appliance driver 2 does not supply power to the illumination unit 3, and the illumination unit 3 is turned off.

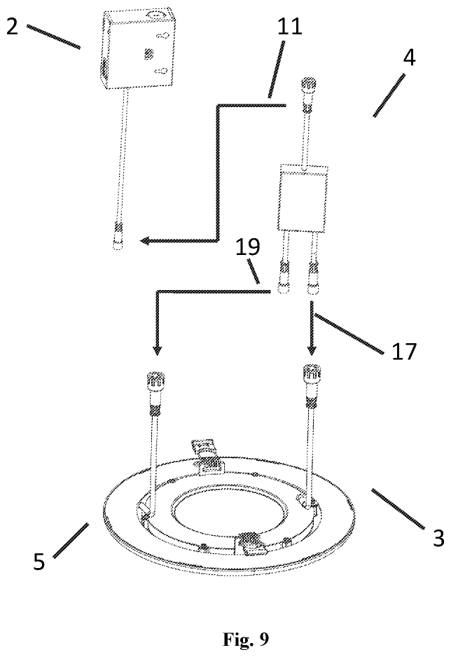

FIG. 9 is a schematic connection diagram of an illumination system according to an embodiment of the present application. As shown in FIG. 9, the second electric appliance driver 4 according to an embodiment of the present application comprises: a power-source power input interface 11 and at least one control signal output interface 17 and 19.

The power-source power input interface 11 is configured to be electrically connected to the first electric appliance driver 2 to receive power-source power. For example, the first electric appliance driver 2 is, such as, a power source providing power-source power to the illumination unit. Whether the first electric appliance driver 2 supplies the power-source power can be controlled by a switch. For example, the power source may be a power source for supplying power to a light in a room, the switch is arranged on a wall, the light is arranged on the roof of the room, and the light is connected to the power source by means of a power source interface on the roof, so as to acquire power-source power from the first electric appliance driver 2. The light is, for example, a can light, a canless light, a night light or illumination units of other types. For example, the first electric appliance driver 2 is provided with an FT1 cable interface for connection to the illumination unit.

The power conversion module 13 as shown in FIG. 5 is electrically connected to the power-source power input interface 11, is configured to receive power-source power by means of the power-source power input interface 11, and convert the power-source power into driving power. For example, the power conversion module 13 may be a voltage conversion module, and the voltage conversion module may convert the voltage of the first electric appliance driver 2 into any other required voltages, for example, a voltage for charging a battery or a voltage for providing power to an electric appliance.

As shown in FIG. 9, the second electric appliance driver 4 further comprises a power-source power output interface 19. The power-source power output interface 19 is electrically connected between the power-source power inlet interface 11 and the additional illumination units 5, and is configured to supply driving power to the additional illumination units 5. In an exemplary embodiment, the illumination unit 3 is a canless light, the additional illumination units 5 are night lights, the night lights are turned on or off by a control signal generated by the control signal generation module 15, and the canless light is directly driven by power-source power supplied by the power-source power input interface 11. For example, the turning on or off of the canless light is directly controlled by a switch. In the technical solution according to an embodiment of the present application, the illumination unit 3 and the additional illumination units 5 can be directly connected to the second electric appliance driver 4, so that power can be easily acquired. In this way, in addition to providing an interface for controlling the illumination unit by the control signal, an interface for directly supplying power-source power to the illumination unit is provided.

According to an exemplary embodiment of the present application, the illumination unit 3 is a canless light, and the additional illumination units 5 are night lights, wherein the night lights are assembled around the canless light. As shown in FIG. 9, the illumination unit 3 of a canless light has an annular edge around which the additional illumination units 5 of night lights are mounted on the canless light. It should be understood that the illumination unit 3 and the additional illumination units 5 may adopt any other electric appliances. In this way, night lights can be provided for the canless light, and the installation is convenient.

According to an exemplary embodiment of the present application, the power-source power input interface 11, the control signal output interface 17 and the power-source power output interface 19 are of the same interface type. For example, the interface type may be an FT1 cable interface. In this way, a standard interface is provided between the power source and the illumination unit, making it possible to connect to other electric appliances of the same interface type.

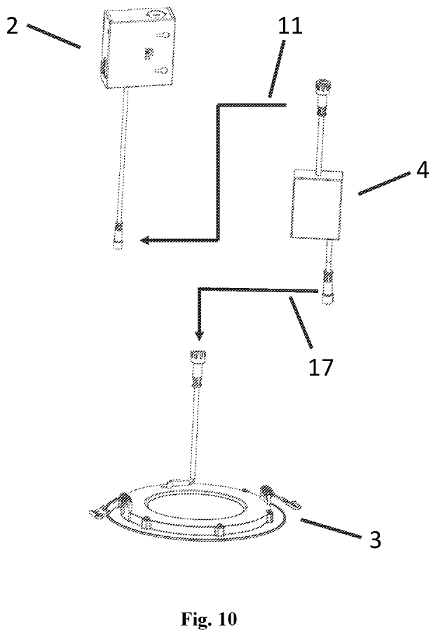

FIG. 10 is a schematic connection diagram of an illumination system according to another exemplary embodiment of the present application. As shown in FIG. 10, the second electric appliance driver 4 is mounted between the first electric appliance driver 2 and the illumination unit 3 such as a canless light. The second electric appliance driver 4 can receive a wireless signal by means of the wireless control module 16 as shown in FIG. 6, and generate a control signal for controlling the illumination unit 3. According to another exemplary embodiment, the second electric appliance driver 4 can receive a wireless signal by means of the wireless control module 16 as shown in FIG. 6, and generate a control signal for controlling the additional illumination units 5. That is, the second electric appliance driver 4 can be used to control the illumination unit or the additional illumination units.

The wireless signal is, for example, a signal sent by a smart mobile device. The smart device is, for example, a mobile phone, a PC, a tablet computer, etc. on which a wireless control APP is installed. Specifically, by means of the wireless control APP installed on the smart device, a user sends a wireless signal by clicking control buttons such as “turn on the light” and “turn off the light”. The wireless signal is received by the wireless control module 16, and the control signal generation module 15 generates a control signal for turning on the illumination unit 3 or the additional illumination units 5 according to the user clicking “turn on the light”, so as to turn on the illumination unit 3 or the additional illumination units 5; or the control signal generation module 15 generates a control signal for turning off the illumination unit 3 or the additional illumination units 5 according to the user clicking “turn off the light”, so as to turn off the illumination unit 3 or the additional illumination units 5.

In this way, a wireless control manner can be provided for the illumination unit or the additional illumination units.

In the technical solutions of the present application, the second electric appliance driver 4 may be a night light driver box, and has a housing and an interface as shown in FIG. 9. The number of control signal output interfaces outputting control signals and the number of power-source power output interfaces outputting power-source power may be any number of 1, 2, 3, or more, which can be set according to needs.

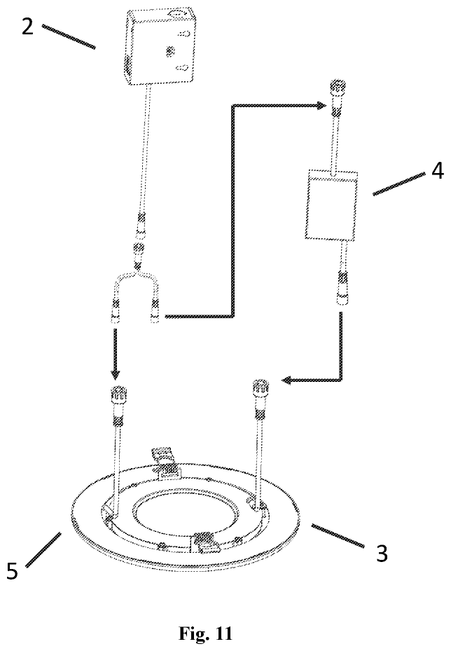

FIG. 11 is a schematic connection diagram of an illumination system according to another exemplary embodiment of the present application. As shown in FIG. 11, the second electric appliance driver 4 is connected between the first electric appliance driver 2 and the additional illumination units 5, and the first electric appliance driver 2 is directly connected to the illumination unit 3. The second electric appliance driver 4 comprises a function control module 18 as shown in FIG. 7, wherein the function control module 18 is configured to control the one or more additional illumination units 5 to achieve one or more functions of turning on at night, turning on periodically and music rhythm.

By means of the technical solutions of the present application, when night lights are mounted on a canless light, it is not necessary to additionally provide power source lines and control apparatuses for the night lights; instead, an original power source interface can be extended into multiple interfaces, so that the canless light and the night lights are controlled at the same time, thereby simplifying the installation work without changing the structure of the existing light, being able to be compatible with any other electric appliances with the same interface. These electric appliances include but are not limited to smoke detectors, motion sensors, etc. When these electric appliances are used, the control logic can be adjusted according to needs, and can also be adapted to power supplied to these electric appliances, thereby improving the extensibility of accessories on which the light can be mounted.

In the described embodiments of the present application, the description of each embodiment has its own emphasis. For the part not detailed in a certain embodiment, please refer to the relevant description in other embodiments.

In the several embodiments provided in the present application, it should be understood that the disclosed technical content may be implemented in other manners. The apparatus embodiments described above are merely illustrative. For example, the division of a unit or a module is only a logical function division, and in actual implementation, there may be another division manner, for example, multiple units or modules or assemblies may be combined, or can be integrated into another system, or some features can be ignored or not executed. In addition, the coupling or direct coupling or communication connection shown or discussed may be an indirect coupling or communication connection through some interfaces, modules or units, and may be electrical or other forms.

The units or modules described as separate components may or may not be physically separated, and the components displayed as units or modules may or may not be physical units or modules, that is, may be located in one place, or may be distributed in a plurality of network units or modules. Some or all of the units or modules may be selected according to actual needs to achieve the purpose of the solutions of the embodiments.

In addition, functional units or modules in the embodiments of the present application may be integrated into one processing unit or module, or the units or modules may exist alone physically, or two or more units or modules are integrated into one unit or module. The described integrated unit or module can be embodied in the form of hardware or in the form of a software functional unit or module.

If the integrated unit is implemented in the form of a software functional unit and is sold or used as an independent product, the integrated unit can be stored in a computer-readable storage medium. On the basis of such understanding, the part of the technical solution of the present application that contributes in essence or to the prior art or all or part of the technical solution may be embodied in the form of a software product stored in a storage medium. Several instructions are included in the storage medium to enable a computer device (which may be a personal computer, server or network device, etc.) to execute all or some of the steps of the methods of various embodiments of the present application. The foregoing storage medium comprises: media such as a USB flash disk, a Read-Only Memory (ROM), a Random Access Memory (RAM), a removable hard disk, a magnetic disk, or an optical disk, and the like which can store program codes.

The description above only relates to preferred embodiments of the present application. It should be noted that for a person of ordinary skill in the present technical field, several improvements and modifications can also be made without departing from the principle of the present application, and these improvements and modifications shall also be considered as within the scope of protection of the present application.

What we claim is:

1. An illumination system, comprising:
a first electric appliance driver, a second electric appliance driver and one or more additional illumination units, wherein
the second electric appliance driver is configured to be electrically connected to the first electric appliance driver and to be electrically connected to at least one additional illumination unit of the one or more additional illumination units, and wherein
the first electric appliance driver can be directly electrically connected to an illumination unit, to form an independent another illumination system.

2. The illumination system according to claim 1, wherein
the illumination system further comprises the illumination unit,
the illumination unit is configured to be electrically connected to the second electric appliance driver to receive driving power, and
the additional illumination units are configured to be electrically connected to the second electric appliance driver to receive driving power.

3. The illumination system according to claim 1, wherein
the illumination system further comprises the illumination unit,
the illumination unit is configured to be electrically connected to the first electric appliance driver to receive driving power,
the additional illumination units are configured to be electrically connected to the second electric appliance driver to receive driving power, and
the second electric appliance driver receives power-source power from the first electric appliance driver.

4. The illumination system according to claim 3, wherein
the second electric appliance driver comprises:
a power conversion module, a power storage and release apparatus and a control signal generation module, wherein
the power conversion module is configured to be electrically connected to the first electric appliance driver to receive the power-source power, and convert the power-source power into driving power,
the power storage and release apparatus is configured to be electrically connected to the power conversion module to receive the driving power, so as to drive the additional illumination units, and
the control signal generation module is configured to receive the driving power from the power conversion module, is also configured to receive the driving power from the power storage and release apparatus, and is also configured to sample an output signal of the first electric appliance driver, and to control, according to the output signal, whether the power conversion module operates and whether the power storage and release apparatus discharges.

5. The illumination system according to claim 4, wherein
the control signal generation module comprises: a control logic module, a detection module and a sensor module, wherein
the control logic module stores a control logic,
the detection module is configured to sample the output signal of the first electric appliance driver, and
the sensor module is configured to measure an environmental parameter associated with the control logic, wherein
the control signal generation module is configured to generate, on the basis of the sampled output signal, the environmental parameter and the control logic and under driving of the driving power, a control signal for controlling whether the power conversion module operates and whether the power storage and release apparatus discharges.

6. The illumination system according to claim 5, wherein
the output signal sampled by the detection module represents the magnitude of the power-source power outputted by the first electric appliance driver,
the environmental parameter represents whether the brightness around the additional illumination units is below a threshold, and
the control logic at least comprises:
if the first electric appliance driver provides the power-source power, controlling the additional illumination units to be turned off and charging the power storage and release apparatus;
if the first electric appliance driver does not provide the power-source power and the brightness around the additional illumination units is below the threshold, controlling the power storage and release apparatus to release the driving power so as to drive the additional illumination units to be turned on; and
if the first electric appliance driver does not provide the power-source power and the brightness around the additional illumination units is above the threshold, controlling the power storage and release apparatus not to release the driving power for driving the additional illumination units, and the additional illumination units being turned off.

7. The illumination system according to claim 6, wherein
the environmental parameter representing the brightness around the additional illumination units is acquired by a photosensitive sensor arranged on the second electric appliance driver or the additional illumination units.

8. The illumination system according to claim 2, wherein
the illumination unit is an illumination system light, and the additional illumination units are night lights, wherein the night lights are assembled around the illumination system light.

9. The illumination system according to claim 1, wherein
the second electric appliance driver comprises a power conversion module and a wireless control module, wherein
the wireless control module is configured to receive a wireless signal, and is configured to output a signal to the power conversion module after receiving the wireless signal; and
the power conversion module has a light adjustment function, so as to turn on or turn off the one or more additional illumination units or adjust the brightness of light emitted by the one or more additional illumination units according to the signal outputted from the wireless control module.

10. The illumination system according to claim 9, wherein
the wireless signal is a Bluetooth signal, a Wi-Fi signal, an infrared signal or other wireless signals.

11. The illumination system according to claim 1, wherein
the second electric appliance driver comprises a function control module, wherein
the function control module is configured to control the one or more additional illumination units to achieve one or more functions of turning on at night, turning on periodically and music rhythm.

12. The illumination system according to claim 11, wherein
the second electric appliance driver further comprises a power storage and release apparatus, wherein
if the first electric appliance driver provides power-source power, the power storage and release apparatus is charged, and the power storage and release apparatus is configured to provide driving power to the one or more additional illumination units.
